(19) United States
(12) Patent Application Publication
(10) Pub. No.: US 2004/0130482 A1
(43) Pub. Date: Jul. 8, 2004

(54) Digital controlled linear sweep frequency mode for FMCW radar altimeter

(76) Inventors: Yu-Shan Lin, Taipei (TW); Feng-Ling Liu, Taipei (TW); Shih-Tung Cheng, Taipei (TW)

Correspondence Address: JOHNSON & ASSOCIATES PC, 14625 BALTIMORE AVENUE #282, LAUREL, MD, 20707, US

(21) Appl. No.: 10/334,719

(22) Filed: Jan. 2, 2003

(51) Int. Cl. G01S 13/32

(52) U.S. Cl. 342/82; 342/83; 342/85; 342/120; 342/122

(57) ABSTRACT

This invention relates to a frequency modulation of continuous wave (“FMCW”) radar altimeter capable of controlled linear sweep modes. The FMCW radar altimeter is characterized by the following functions: (1) adopts sweep up frequency and sweep down frequency to solve problems of distance and doppler signal mixture; (2) injects a random generated variable time delay in between sweep intervals to overcome interferences among different altimeters; and (3) switches different sweep frequency bands in accordance with different altitudes.

### BACKGROUNG OF THE INVENTION

1. Field of the Invention

The present invention relates to FMCW radar altimeter. Specifically, the invention relates to a FMCW radar altimeter with digital controlled linear sweeping modes.

2. Related Prior Art

Conventional FMCW radar altimeter uses a basic technology to transmit linear sweep frequency signal with varying frequency in time domain. As linear sweep frequency signal is launched from earth's surface or an object, a reflected wave will be generated with a time delay relative to the distance of the altitude. The generated reflected wave will mix with the transmitted wave to generate beat frequency output, whose altitude distance can be calculated from such time delay function. Conventional FMCW radar altimeter also employs voltage controlled oscillator (VCO) to generate linear sweep signal.

During practical use of conventional FMCW altimeter various factors affect their operation and calculation. For instance, angle error incurred during flight between altimeter and earth surface, multi-path reflection nearby altimeter, mutual interference among different altimeters and the doppler signal mixture problem. To maintain sweep signal at a conventional fixed sweep bandwidth requires complex electrical circuits and the linearity and precision of the generated wave is not so accurate. Thus, maintaining conventional fixed sweep bandwidth requires extra electronic circuits to calibrate the calculation.

### SUMMARY OF THE INVENTION

An object of the digital controlled linear sweep FMCW radar altimeter invention is to solve the aforementioned problem associated with radar altimeter of the prior art, by using programmable direct digital synthesizer (DDS) to generate high precision and better linearity waveform of chirp sweep or linear frequency sweep.

Another object of this invention is to use sweep modes of sweep up and sweep down, plus random generated variable time delay interval in between swept periods to solve the problems associated with mutual interference among different altimeters and doppler signal mixture.

Still another object of this invention is to simplify digital signal processor (DSP) module for distance calculation, and to control output bandwidth of DDS to maintain beat frequency within 20 KHz of intermediate frequency (IF).

The present invention will be readily apparent upon reading the folilowing description of a preferred exemplified embodiment of the invention and upon reference to the accompanying drawings.

### BRIEF DESCRIPTION OF DRAWINGS

FIG. 1 illustrates sweep frequency waveform of digital controlled linear sweep frequency mode for FMCW radar altimeter of the present invention.

FIG. 2 illustrates sweep mode switch rules of digital controlled linear sweep frequency mode for FMCW radar altimeter of the present invention.

FIG. 3 illustrates sweep slopes of five modes of digital controlled linear sweep frequency mode for FMCW radar altimeter of the present invention.

FIG. 4a illustrates frequency curves of transmitted and reflected wave of the FMCW radar of the present invention.

FIG. 4b illustrates beat frequency of transmitted and reflected waves of the FMCW radar of the present invention.

FIG. 5 illustrates a system block diagram of the digital controlled linear sweep frequency mode for the FMCW radar altimeter of the present invention.

### DETAILED DESCRIPTION AND PREFERRED EMBODIMENTS

The features of the digital controlled linear sweep frequency mode for the FMCW radar altimeter of the present invention will be described as follows:

1. Transmit sweep frequency waveform

(a). to adopt sweep up and sweep down modes to solve distance mixed with doppler signal problem; and (b). to add in a random generated variable time delay interval in between swept periods to solve problem of mutual interference among different altimeters.

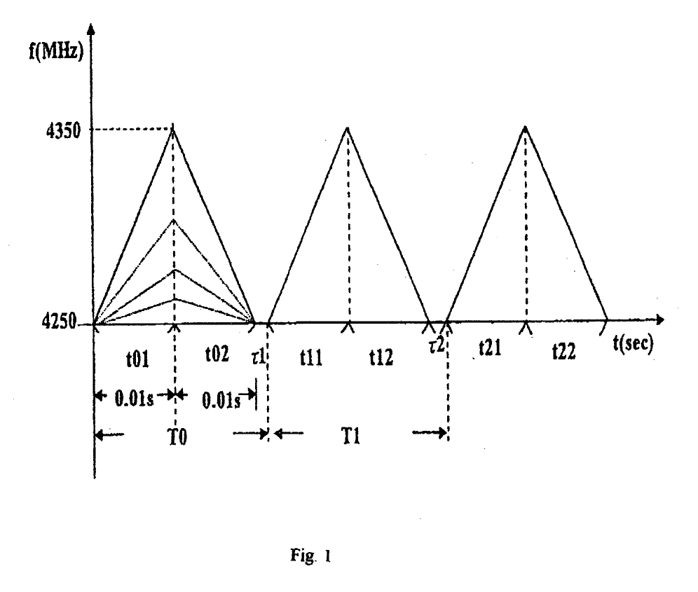

The waveform generated is shown in FIG. 1, wherein τ1 and τ2 are the random time delay generated by DSP for differentiating the interferences among different altimeters. FIG. 1 illustrates sweep frequency waveform of the digital controlled linear sweep frequency mode for FMCW radar altimeter of the present invention, wherein t01, t11 and t21 .. . represent sweep up waveform, t02′ t12′ t22 .. . represent sweep down waveforms and τ1 and τ2 represent random time delay. The sweep mode has five modes for selection.

The method will be described as follows with reference to FIG. 1 and table 1:

a. initialization:

Mode=0 (FS=100 MHz)

perform sweep up (tO 1) and calculate value of altitude;

b. during t02′ τ1′ t11 time intervals

t02: to perform sweep down

τ1: to generate random time delay

t11: to perform sweep up

During these intervals, used eq. 2 (shown in the detailed description below) to solve the problems of the doppler mixture phenomenon, mutual interference among altimeters and object discrimination by using DSP for data processing to obtain an accurate altitude value.

c. during the processing, if the beat frequency fb is not within 3 k˜10 kHz range then proceed to the following processing method:

(i) if fb>10 KHz reduce sweep rate, for example, switch mode from mode 0 to mode 1; (ii) if fb is still larger than 10 KHz, continued to reduce sweep rate; the lowest is mode 4 (sweep rate=6.25 MHz/0.01 sec); and (iii) if fb<3 KHz increase sweep rate, the highest is mode 0 (sweep rate=100 MHz/0.01 sec).

d. during t12′ T2′ t21 time intervals

the operation is as same as item b and c shown above and so on.

2. switch of sweep modes

In order to simplify the digital signal processor (DSP) module for the distance calculation and maintain measurement precision, the output bandwidth of the DDS has to be controlled to maintain beat frequency within 20 KHz of intermediate frequency From eq. 1 (shown in the detailed description below), it indicates that when the altimeter is above terrain at higher level, the beat frequency is also higher because reflected wave takes longer time, and because the sweep frequency bandwidth and the beat frequency fb are inversely proportional. Therefore by controlling the sweep frequency bandwidth one can maintain fb within a certain bandwidth.

The present invention has categorized sweep frequency mode into 5 modes, as shown in table 1 below. When the altimeter is above terrain at higher levels the sweep frequency bandwidth is narrower. On the contrary, when the altimeter is above terrain at lower levels the sweep frequency bandwidth is wider. The system of the present invention will change the sweep frequency being used in accordance with the current distance. Five modes of sweeping slope are shown in FIG. 3.

In addition, FIG. 3 illustrates a five mode sweep slopes of the digital controlled linear sweep frequency mode for the FMCW radar altimeter of the present invention, wherein the most upper one is mode 0 with the largest slope, and the most lower one is mode 4 with the smallest slope. The selection of the slope of the sweep mode depends on the size of beat frequency fb, so as to keep tb within a certain bandwidth thereby simplifying the design complexity and maintaining accuracy of measurement.

TABLE 1
sweeping modes

| Modes | Sweep range (MHz) | Sweep bandwidth | |
|---|---|---|---|
| Mode 4 | 4250-4256.25 | 6.25 | MHz |
| Mode 3 | 4250-4262.5 | 12.5 | MHz |
| Mode 2 | 4250-4275 | 25 | MHz |
| Mode 1 | 4250-4300 | 50 | MHz |
| Mode 0 | 4250-4350 | 100 | MHz |

The actual operation is described as follows:

During processing, if the beat frequency fb is within 3 k˜10 kHz range the sweep frequency mode will not change, but if beat frequency fb is not within 3 k˜10 kHz range then switch the sweep frequency mode according to the rules below:

If fb is >10 KHz reduce sweep rate, for example, switch mode from mode 0 to mode 1. If fb is still larger than 10 KHz continued to reduce sweep rate; the lowest is mode 4 (sweep rate 6.25 MHz/0.01 sec). If fb is <3 KHz, increase sweep rate; the highest is mode 0 (sweep rate=100 MHz/0.01 sec).

The principle of operation will be described as follows:

1. For the relation between object to be measured and sweep

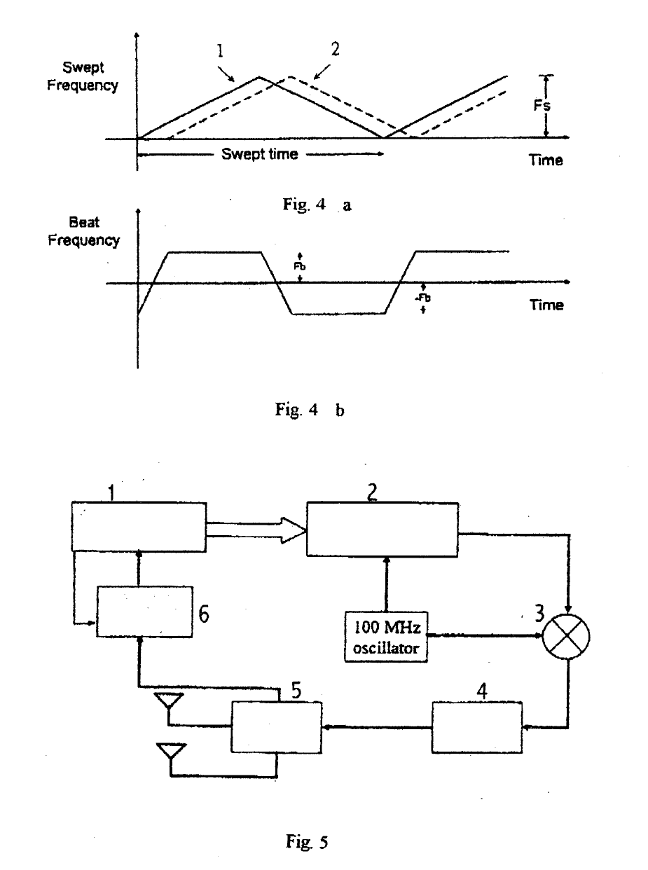

frequency bandwidth referred to FIGS. 4a and 4b; beat frequency

fb can be calculated by eq. 1 below:

fb=(2R/cT)Fs eq. 1

where T is the sweep time, c is the speed of light, Fs is the sweep bandwidth, and R is the distance of the object to be measured.

From eq. 1, when R increases fb also increases; fb will be fed to the DSP module circuit after being filtered at the intermediate frequency (IF) stage to calculate distance. In order to maintain a constant bandwidth and simplify the design complexity with accurate measurement, the value of fb should be kept within a constant bandwidth. Thus the best way to keep fb @a constant is to change value of Fs, resulting in an inverse relationship between R and Fs.

2. To solve doppler signal mixture phenomenon when the carrier of the altimeter is in movement, fb in eq. 1 must contain the data having both doppler signal and distance mixture. In order to sort out exact distance one has to adopt sweep up and sweep down as shown in eq. 2.

f_{b}=(2R/cT)Fs=kR

→f_{b1}=kR−f_{d}′f_{b2}=kR+f_{d}

→R=(f_{b1}+f_{b2})/2k′f_{d}=(f_{b2}−f_{b1})/2 eq. 2

Wherein the sweep up beat frequency is f_{b1}; the sweep down beat frequency is f_{b2}; and f_{d} is the doppler frequency. The rest of this invention will be readily apparent upon reference to the rest of the accompanying drawings in the specification.

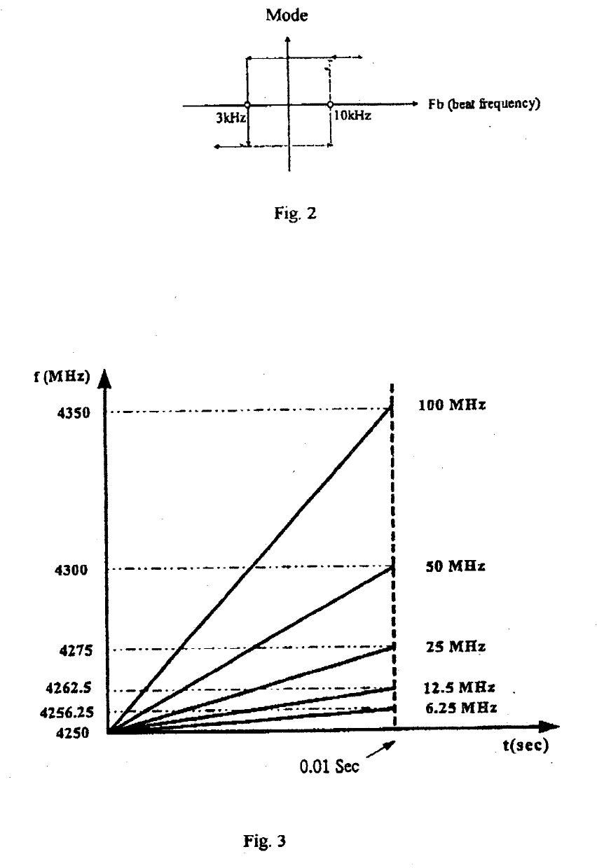

FIG. 2 illustrates a preferred exemplified embodiment of the present invention. If fb>10 KHz reduce sweep rate, for example, switch mode from mode 0 to mode 1 (as shown in Table 1). If fb is still larger than 10 KHz continued to reduce sweep rate. In order to keep fb within the range of 3 KHz-10 KHz, the lowest mode should be 4. On the contrary, if fb<3 KHz, increase sweep rate, for example, from mode 4 to mode 3 (as shown in Table 1). If lb is still smaller than 3 KHz, then keep increasing sweep frequency. The highest is mode 0, in order to keep fb within the range of 3 KHz-10 KHz.

FIG. 4 illustrates frequencies of transmitted and reflected waves of the present invention. FIG. 4a illustrates frequency curves of transmitted wave 1 and the reflected wave 2 of the FMCW radar. Similarly, FIG. 4b illustrates beat frequency of the transmitted and the reflected waves of the FMCW radar, wherein solid line represents transmitted wave, and dot line represents target reflected wave.

FIG. 5 illustrates a system block diagram of the digital controlled linear sweep frequency mode for the FMCW radar altimeter of the present invention. The operational principle of FIG. 5 described below is a preferred exemplified embodiment of the present invention.

Referring to FIG. 5 of the drawings, the digital signal processor DSP 1 is incorporated with the digital I/O port of the direct digital synthesizer DDS 2 to output, for example, a sweep signal between 21.428-24.3 MHz. After the direct digital synthesizer DDS 2 output a sweep signal, if is coupled through a mixer 3 and a frequency multiplier 4, and then amplified by transmit/receive module 5 to procedure an altimeter radar output; for example, 4.25-4.35 GHz FMCW sweep wave. Received RF signal and transmitted RF signal are mixed in mixer 3 to get the desired beat frequency fb, which is proportional to the altitude value.

Still referring to FIG. 5, the DSP 1 is incorporated with digital I/O port of gain control STC 6 to process inputted beat frequency lb by controlling the gain control STC 6 to keep fb within intermediate frequency (IF) such as 20 KHz; subsequently, the IF signal will be retrieved by the A/D converter to digitize the signal. After the intermediate frequency (IF) signal has been digitized and calculated through the Fourier fast transformation (FFT), the maximum power frequency is then located via the DSP.

This frequency represents the signal reflected by the earth's surface and processed as abovementioned, which is proportional to the altitude and the value of the altitude can be obtained through proper scale transformation. If said frequency is not within 3-10 KHz, then select an appropriate sweep mode in accordance with the aforementioned rules for selection to control DDS 2 to output sweep signal in between; for example, 21.428-24.3 MHz by using the DSP.

From above descriptions, it is understood that the present invention uses sweep modes of sweep up and sweep down, and adds in a random generated variable time delay interval in between swept periods, and switches to different sweep frequency bandwidth with different altitude to solve problem associated with mutual interference among different altimeters and doppler signal mixture problem. Various additional modification of the embodiments specifically illustrated and described herein will be apparent to those skilled in the art in light of the teachings of this invention. The invention should not be construed as limited to the specific form and examples as shown and described. The invention is set forth in the following claims.

What is claimed is:

1. A digital controlled linear sweep frequency mode for FMCW radar altimeter which 1) adopts sweep up frequency and sweep down frequency to solve problem associated with mixture of distance and doppler signals; 2) injects random generated variable time delay, in between sweep intervals, to overcome interferences among different altimeters, and 3) switches different sweep frequency bands in accordance with different altitudes.

2. The digital controlled linear sweep frequency mode as in claim 1, wherein when the altimeter is above terrain at higher levels the sweep frequency bandwidth is narrower; and when the altimeter is above terrain at lower levels the sweep frequency bandwidth is wider; and said sweep frequency bandwidth is switched in accordance with the altitude distance.

3. The digital controlled linear sweep frequency mode as in claim 2, wherein the sweep mode total five modes.

4. The digital controlled linear sweep frequency mode as in claim 1, wherein said sweep mode switch to different sweep bandwidth is based on beat frequencies of its transmitted and reflected wave; and when the beat frequencies are larger than a high limit value, said sweep bandwidth is switched from a current sweep bandwidth mode to a lower sweep bandwidth mode; and when the beat frequency is smaller than a low limit value, said sweep bandwidth is switched from a current sweep bandwidth mode to a higher sweep bandwidth mode.

5. The digital controlled linear sweep frequency mode as in claim 4, wherein said high limit value and low limit value are 10 KHz and 3 KHz respectively.

6. A digital controlled linear sweep frequency mode system for FMCW radar altimeter comprising a digital signal processor, a direct digital synthesizer, a mixer, a frequency multiplier, a transmit/receive analog module, a transmit/receive antenna and a gain control circuit.

7. The digital controlled linear sweep frequency mode system as in claim 6, wherein said intermediate frequency of said transmit/receive analog module is 20 KHz.
